(19) United States
(12) Patent Application Publication
(10) Pub. No.: US 2018/0315138 A1
(43) Pub. Date: Nov. 1, 2018

(54) INTERACTIVE FOOD AND DRINK ORDERING SYSTEM

(71) Applicant: ORDAMO LIMITED, London (GB)

(72) Inventors: Martin RIDDIFORD, London (GB); Daniel POTTER, London (GB); Noel HUNWICK, London (GB)

(21) Appl. No.: 16/014,018

(22) Filed: Jun. 21, 2018

Related U.S. Application Data
(63) Continuation of application No. 14/524,759, filed on Oct. 27, 2014.
Application No. 14/524,759 is a continuation of application No. 12/518,186, filed on Dec. 22, 2009, now abandoned.

(30) Foreign Application Priority Data
Dec. 13, 2006 (GB) 0624885.0
Feb. 13, 2007 (GB) 0702779.0

(51) Int. Cl. G06Q 50/12; G06Q 20/20; G06F 3/0482; G06F 3/0484; G06Q 30/06

(52) U.S. Cl. CPC G06Q 50/12; G06Q 20/20; G06Q 30/0603; G06F 3/04842; G06F 3/0482

(57) ABSTRACT

An interactive food and/or drink ordering system, in which a computer controlled projector is mounted above a surface such that a menu of food and/or drink selection options is projected onto some or all of the surface. The selection options are selectable by a user operating an interface device connected to the computer, such as a wireless track pad.

### CROSS REFERENCE TO RELATED APPLICATIONS

This application is a continuation of U.S. application Ser. No. 14/524,759, filed on Oct. 27, 2014, which is a continuation of U.S. application Ser. No. 12/518,186, filed Dec. 22, 2009, which claims the priority of PCT/GB2007/004791, filed on Dec. 13, 2007, which claims priority to Great Britain Application No. 0624885.0, filed Dec. 13, 2006, and Great Britain Application No. 0702779.0, filed Feb. 13, 2007, the entire contents of which are hereby incorporated in total by reference.

### BACKGROUND OF THE INVENTION

### 1. Field of the Invention

This invention relates to an interactive food and/or drink ordering system and method; customers directly input their orders into an electronic point of sale system. The system eliminates the need for a waiter to take an order. The invention can be used in restaurants and other locations where food and/or drinks are served.

### 2. Description of the Prior Art

There is considerable pressure on restaurants to increase the speed and reliability with which orders are taken and also the speed at which a bill (“check” in US English) is presented to a customer after requesting. One approach to addressing this problem is to provide a large touch screen monitor plus PC embedded into each table top. The monitors are connected to the menu point of sale system that provides orders to the kitchen. But the tables are very costly and the combined screens/tables can be damaged if the table is knocked. The glass (or acrylic) tops of these tables also have to be thick, making the tables very heavy and hence difficult to move—a problem in many restaurant environments, especially for cleaning.

Another problem with touch screen displays with very thick glass is that the actual display surface can be several mm away from the top surface—introducing a barrier and related parallax effects, which can make the process of using them seem unnatural. A further problem is that providing power and data cabling to tables in a restaurant can be very costly.

### SUMMARY OF THE INVENTION

The invention is an interactive food and/or drink ordering system, in which a computer controlled projector is mounted above a surface such that a menu of food and/or drink selection options is projected onto some or all of the surface, the selection options being selectable by a user operating an interface device connected to the computer.

The computer may be connected to an EPOS (electronic point of sale system) and provides information to kitchen and/or bar staff to determine what food and/or beverages will be prepared.

The invention will be implemented in a London based restaurant called ‘inamo™’. At inamo, control over the dining experience is placed firmly in the hands of the customer through interactive customer ordering.

The concept of the inamo restaurants is to provide dining theatre through a projector mounted above each table. This projector projects a user interface for bespoke software called ‘WES’ onto the table surface. An EPOS (electronic point of sale) system is the back end to the WES system. The front end of this WES system is controlled through a rechargeable Bluetooth track pad interface device built into the table. The user interface includes simple lists of food/beverage items with related icons and buttons that a user can select using the track pad, with the pointer controlled by the track pad also projected onto the table surface. In addition to ordering food and drink, the customer can customise the ambience of the table lighting using WES. Any image including streamed films, coloured lighting, and images of what the customer could order can be shown using the overhead projectors. The WES system therefore provides malleable decor through the unique table lighting and customisable ambience.

In principle, the tables need not be specially designed for the system since any table with a white table cloth will do. This is a major advantage over prior art systems with touch panels and PCs embedded into the table itself. No power need be supplied to the table at all; for example, the track pads can be powered by a rechargeable battery, with a power cable pulled down from the projector housing perhaps once per week to recharge each track pad. It is far better to have power and data cabling running to a ceiling mounted housing (the housing then includes the LCD projector and client PC computer) because restaurants often either have false ceilings or they make a feature of having exposed cabling. In any event, it is far simpler to provide data and power to ceiling mounted devices than to tables.

Some strengths include: Customers are in total control of the dining experience. Service is highly efficient with the average order-delivery delay being under ten minutes and the bill payment process taking under five minutes for a group of four. Customers are not put off inamo by negligent service. Lower operating costs through increased efficiency; faster ordering, fewer customer inhibitions about ordering, faster service for customers; further, less work for waiters, so reducing staff costs. Appendix I lists the enhanced operating aspects delivered by implementations of the present invention.

### BRIEF DESCRIPTION OF THE DRAWINGS

FIG. 1 shows a diagram of a typical table layout for an individual diner, such as just before the start of the ordering process.

FIG. 2 shows a diagram of a typical table layout for an individual diner, such as just after the beginning of the ordering process.

FIG. 3 shows a diagram of a typical table layout for an individual diner, showing the initial layout of the user interface, and the part of the user interface which will function after an order has been placed, labelled RH.

FIG. 4 shows a diagram of a typical table layout for an individual diner, showing an example of what appears when the customer initially chooses to view the menu.

FIG. 5 shows a diagram of a typical table layout for an individual diner, when the diner is adding food to his order.

FIG. 6 shows a diagram of a typical table layout for an individual diner, after the diner has added a single food item to his order.

FIG. 7 shows what is seen in the right-hand user interface during the process of being offered the choice of removing an item from the order.

FIG. 8 shows a table ready to be served with one large dish, one small dish and rice ordered by the customer. Note that the large dish and the small dish occupy containers of the same diameter.

FIG. 9 shows a diagram of a typical table layout for an individual diner, showing an example of what appears when the customer chooses to view the main wine drinks menu.

FIG. 10 shows a diagram of a typical table layout for an individual diner, showing an example of what appears when the customer chooses to view the sparkling wine or champagne drinks menu.

FIG. 11 shows a diagram of a typical table layout for an individual diner, showing an example of what appears when the customer chooses to view an individual item on the drinks menu.

FIG. 12 shows a diagram of a typical table layout for an individual diner, showing an example of what appears after the customer has selected an individual item on the drinks menu.

FIG. 13 shows a diagram of a typical table layout for an individual diner, showing an example of what appears after the customer has chosen to review the bill (or “check” in US English).

FIG. 14 shows a diagram of a typical table layout for an individual diner, showing an example of what appears after the customer has selected the “Bring Table Bill” option (or “Bring Table Check” option in US English).

FIG. 15 shows a diagram of a typical restaurant table system which implements an example of the invention, and the connection of the restaurant table system via a server to other peripherals or networks.

### DETAILED DESCRIPTION

A projector (for example, housed within custom built lampshades) is mounted above each table. This projects the WES software user interface onto the whole table, thus being shared by both customers at a two person table. The front end of this system is controlled through a Bluetooth track pad. The track pads are built directly into the table. Any other suitable form of pointing or control device can be used, including wireless untethered wands. Any image, including streamed films (including from the kitchen: a chef-camera), coloured lighting, and even images of what the customer has ordered (or could order) can be projected on to the customer's table surface and even onto the plate at his table.

Although, in principle the system could function through the projection nodes above the tables alone and without custom built tables, inamo uses custom built tables; each table is fixed and sits two people. The tables are modular and can be linked together to seat groups of any size.

The customer is able to place orders and pay his bill as and when he chooses, without the need to attract the attention of a waiter. The waiter will be informed that a table wishes to pay through an EPOS system. The concept of customer control extends to the ambience in the restaurant as every customer can control the overhead projectors to alter the colour, shade and brightness of lighting at his table to exactly that which he desires, including the possible placement of skins, backgrounds and even famous works of art onto his table surface, all by interfacing with the WES software using the track pad controllers. Upon walking in to the restaurant, an individual will be presented with a mix of many lighting colours which will be unique to that instant in time and represent the mood and personality of every customer in the restaurant.

To allow the customer to use the WES interface with the greatest ease and clarity, the table surface should be as clear as possible. Custom designed 20 cm plates and bowls will be used in the inamo restaurant.

The WES software will feature an Extras menu which will offer various exciting practical and entertainment services. The customers will be able to book taxis with a local taxi firm. There will also be details of local bars and clubs which offer alternative venues where the customer can end his evening. Some simple games will be provided.

By combining the WES system with a high quality website of similar design, we can provide not only for swifter ordering, bill presentation, payment processing and fairer tipping, but also integrate everything into an online booking service. In conjunction with the WES software and side applications, the restaurant website will have various features. Customers will have the ability to book online, including for peak periods. Email or SMS reminders of bookings will be sent. Potential customers will also be able to browse current menus online to help convince them to make a booking. A list of up and coming events at our venue will also appear on the website.

The WES software will be built so that additional modules can be added on to the system.

On Monday or Tuesday nights, when many restaurants often struggle most to entice customers inamo can offer a unique and different experience given by a single one of our ever accruing entertainment modules. It will be possible to host various events for businesses, entrepreneurs and artists, such as a showcase of a fashion designer's work, using images on the walls and tables, and models; or an exhibition of artists' work with projected images and physical displays; or new product launches.

In an industry where barriers to entry are small and typical margins for successful operations lie between 6 and 10 percent, the benefits of the WES software from the point of view of marketability, customer satisfaction and process efficiency are great.

The invention can be used not just in restaurants, but wherever there is a need to provide fast, efficient, customer focussed hospitality. For example, it could be implemented in airplane or train cabins (e.g. for food or film/games ordering), at hotel reception desks (e.g. for checking in).

### Guiding Principles Behind the WES System

### What the Product Must Deliver

Below are the things that WES achieves/rules that it obeys. The first three design principles (below) trump all others.
1. Almost anyone can walk in off the street and use it, without help.
2. Above all else, Ordering and Ambience Control must be absolutely obvious to use. Obvious and pleasurable to use.
3. This design must first and foremost work well for the inamo delivery of dishes—All dishes will be served on custom designed plates or bowls (the most common and largest of which are 16-20 cm in diameter). The customer will be able to choose from small dishes, large dishes, set menus and desserts on the food menu.
   Overall, any intrusion of computing technology or terminology would have a bad effect on a typical customer's experience. So, as far as possible, terminology and UI-components from the world of computing should be avoided. (So, no Back, Undo, scrollbars, tickboxes, Web Browser controls, OK, Cancel . . . even lists, maybe. “Click to select” even. For selection, rather than lists and menus, think top-level of DVDs . . . No “add to cart”. . . )
   The interface must be able to work exclusively in the righthand area, when required—when the table area is not available.
   Ordering in a normal restaurant is quick, easy and pleasurable. If there is a danger that ordering here looks & feels like the same process except that only small amounts of text can be shown at once, and you have to use point-and-click to choose, people might well feel that ordering feels exactly the same as in a normal restaurant except that every single stage of it is harder/more unpleasant. So with that in mind, the goal is that ordering should feel quicker, easier and more pleasurable than ordering in a normal restaurant.
   Ideally it must assuage any fear of using it, showing you right from the off that it is going to be easy.
   In a one-hour turnaround restaurant, we don't want customers sitting there for 45 minutes playing with the software. So, we do not want endless options—just an interface that has real simplicity for the user. There is no “trying out every option”, or “investigating deeper”. Particularly when the restaurant is full, the software should encourage customers to get on with it.
   The UI should interfere with well established physical restaurant processes as little as possible. For instance, the places in which customers are accustomed to putting their glassware, to the right hand upper side of the plate.
   It should feel new, different, original, theatrical, charming, animated without being annoying, and appropriate to potentially expensive surroundings.

### Constraints

Very limited table space.
Limited resolution of projection

The above two constraints mean that only a rather limited amount of UI can be shown on the table at once.
We must not force our diners to behave in abnormal ways—eg to keep a plate exactly in one place, or to be banned from putting anything whatsoever on the table. (For the inamo version at least. Other implementations in other restaurants may do this differently.)

### Relevant Interface Design Principles

Not specific to this project, the following general principles of UI design will be adhered to as far as possible:
Rather than trying to give the user every choice on the screen at the same time, it is much better to demote/hide/categorise options, so that the screen looks clearer and easier to understand. Too much choice is no choice: if you support dozens and dozens of options or features, people will be unable to spot the one they want anyway. (Despite the obsession of some usability people with it, the number of clicks that it takes you to get from A to B is nothing like as important to user happiness as the obviousness of doing so, and a comparatively clear screen not covered with options is a key part of this.) However, reflecting a typical restaurant ordering experience can of course override this—you don't need to sub-categorise everything on the menu, for example, when a normal restaurant menu is entirely what people expect to see.
Show things visually, not by using large amounts of text. Where possible, show relationships between different things visually.
As far as possible no “error” situations should be possible, and those that do occur must (a) never say “error” or imply a mistake on the part of the user, and (b) always show the way forwards from there.
Your user should not have to remember things from one screen/situation to another—keep ongoing information displayed onscreen.
Offer clearly marked exits, for any common “get me out of here” situation.
Discoverability: everything should become obvious by attempting to use it, rather than there being anything you might not pick up immediately. (In a pointer interface like this one, a simple solution is that if you point at something, and leave the pointer there for a noticeable amount of time, the things that you can do with the thing you're interested in should become obvious.)
Use only terminology your user understands.
Use only terminology appropriate to potentially expensive surroundings. Sometimes even slight carelessness over terminology can seriously harm the acceptance of the overall product.
The system will need to adapt and resize objects etc. to allow one customer to order an arbitrarily large number of items.
The system will be statefull; i.e. a customer can simply jump about the UI by pressing food, drink, extras etc. and when she does this, she does not lose what she was doing in the previous screen. As such all top level processes should always have a defined end which takes them back to the main screen (or start/launch screen) so that the customer does not feel confused by too much going on at once.
We need, in all that we do, to ensure that the customer is not overwhelmed by the constant exposure to the bright light and dynamic animation that is presented to them. Being exposed to a bright projector at such close distance could easily become distracting, annoying and even physically painful.

### Table Geography

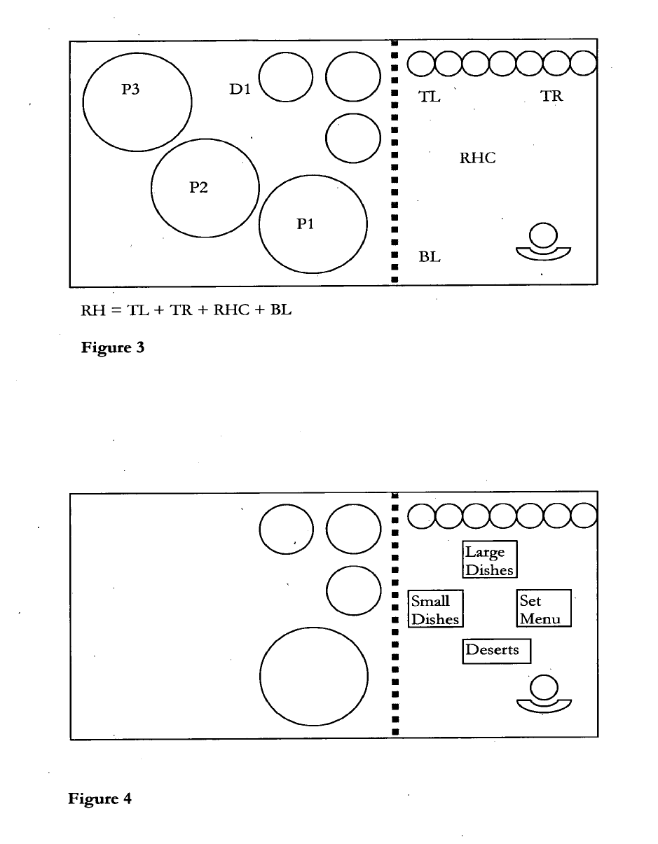

This section will define the areas on the table which we expect to be occupied by miscellaneous dining materials, and where on the table will be available for the projection of the UI. The exploration of this table geography has led us to make several key observations about the physical objects likely to be on the table at various points during the dining experience:
Tables—we are working on the basis of a 75×75 cm table.
Plates—We will use custom designed plates/bowls with a diameter of 16 cm. These may be stackable. The customer will comfortably be able to have up to 3 dishes on the table at once.
Glassware—typically customers place their glassware to the top right hand side of their plate in a normal restaurant. In line with our goal of maintaining normal restaurant experiences we will not disturb this. Waiters will deliver drinks in the area which we have defined in an attempt to guide the customer (who will likely naturally avoid areas with obvious UI projections anyway). Initially there will be no glassware on the table unless the customer ordered a drink from the bar and the waiter brought it over for them.
Wine bottles—due to the currently envisaged table orientations and gaps between tables, placing wine bottles in buckets at the side of tables may obstruct entrance and exit to some seats. As such we will provide space on the left hand side of each diner which can be used for this purpose and for miscellaneous customer clutter.
Condiments—We will not provide condiments automatically on the table. Condiments can be requested and brought as required salt, pepper, chilli sauce and soy sauce will arrive on a piece of custom designed inamo crockery which will be the same diameter as the glassware at the base. In order to get the condiments, the customer will have to use the call waiter option (described later).
Beer bottles—will be delivered on the left hand side of the table; not next to the rest of the glassware.
Chopsticks—will be present when the customer sits down at the table, horizontally oriented above the plate area. If a customer wishes for a knife and fork he can request one from the waiter when he brings the dish. The waiter will bring cutlery with any dishes that self evidently require cutlery other than chopsticks. Places will be set with the minimal amount of cutlery.
Track pads—These will be to the right hand of each customer in the corner of the table. It is possible to alter the shape and colour of the track pad to disassociate it from normal laptop track pads. We may operate a hover to select functionality and in this instance the track pad would not have a clickable button.
Key buttons—These will always appear in the top right hand area of the table labelled TR.
Interactive part of UI—All interactivity with the UI will appear in the areas labelled RH and TR. Certain features within the Extras may allow the customer to utilise the left hand part of the UI.
Display features of UI—Initially the areas labelled P1, P2, P3 and DI (see FIG. 3) will be used to display food and drink items. After food and drink have been ordered these areas will not be used for this purpose.
Customer Messages—These will appear to the left of the track pad in the interactive part of the table. Note that if there is a speaker directed to a single customer, these messages could be audio as well.

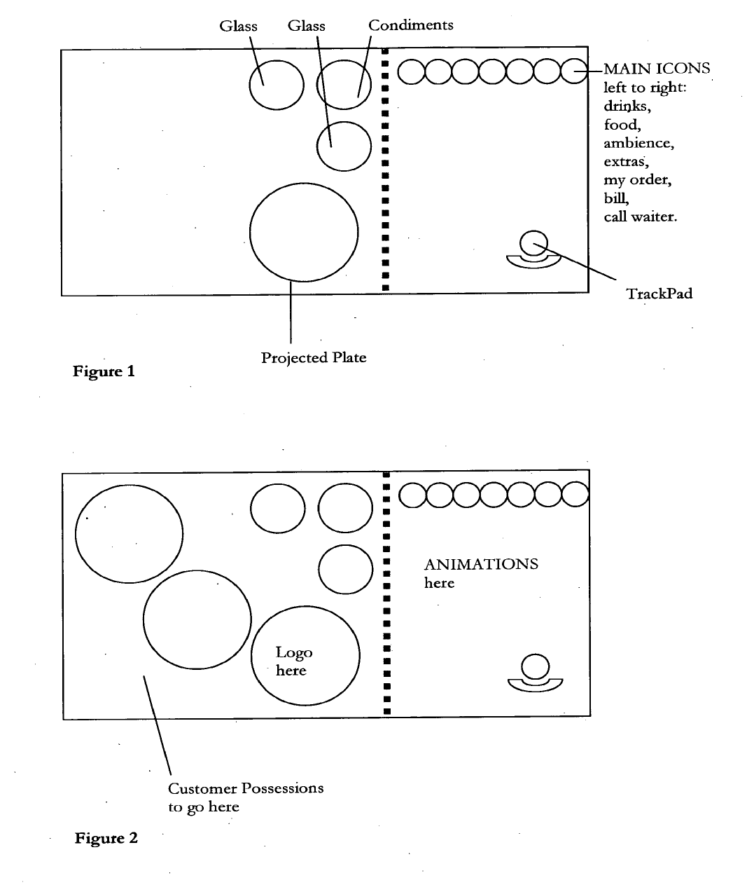

FIG. 1 schematically illustrates a typical UI for the WES system. To the left of the dashed line is the left hand (LH) side on which plates etc will be placed. Running along the top of the right hand side (RH) we have the main icons for each of the top level functions for:
Drinks
Food
Ambience
Extras
My Order
Bill
Call Waiter

Hence, selecting ‘Drinks’ causes WES to display the drinks menu, from which the customer can select the drinks he wants. Likewise, selecting the ‘Food’ items causes WES to display the food menu etc.

### Pointing Device

There are many different interaction device options. Some options include:
One-to-one Pointer
One-to-one Keypad interface
One-to-one Touchscreen style interface
i-POD style Rotational interface
Buttonless track pad interface
1 button track pad
Laser keypad interface
Infra red sensor installed with projection unit

There is no absolute, objective, and correct answer as to which of these solutions is the best solution for a specific restaurant. For inamo, we have a simple 1 button track pad.

### Food at Inamo

The customer will be served food in dishes which are 16 cm in diameter and of varying depth. This food will be Asian fusion cuisine and served as either smaller or larger dishes rather than the conventional starters, main courses and side dishes.

Customers will receive their food as and when it is ready in chronological order and not grouped to all arrive at the same time. The open ended nature of food and drink ordering at inamo means it would be very difficult to group food items ordered by table. As a compromise solution to this there will be some grouping of food but customers will need to be informed that food will arrive when it is ready. This will happen as follows and apply to all groups of more than one person. For a group of 5 people (5 individual terminals grouped into a table of 5 by the POS system) the first person to place a food order will create a delay (not visible to the customer) of 3 minutes in the food ordering process. During this time, any subsequent food orders placed by anyone in the table of 5 will be processed as a single order by that table (This will apply to drinks too). 3 minutes after the first food order is placed, regardless of what other people on the table of 5 are doing, all food orders placed during that time will be grouped into that order and any subsequent orders will each be placed as separate, independent orders.

### System Wide Interface Issues

Hover Functionality

There are two different interface functionalities. The primary version of this is a track pad with a button offering a simple point and click interface the whole document has been written from this perspective. The other option is a track pad with no button such that we offer zero click ordering—and all processes are done by hovering over objects with one or more fingers, with the palm of the hand, with an opaque implement, or with a transparent implement which alters the direction of light propagation.

### Quick Clicks

If using a combination of point and hover functionality, if you do decide to point at something and click immediately, that just acts the same as a ½ second hover.

### Skinning

If used, this should include everything in the UI. In some skins some actions might not even take place.

### Transitions and Interfaces

This can make the experience more pleasurable. The keywords charm and theatre should be prevalent in all of the motion that brings to life the situations expressed in this document.

### ‘Mousepointer’

The ‘mousepointer’ should go thick/bold when moving significantly, so you pick up where it is easily, and semi-transparent (or outlined) when still over an object, so that you can see exactly what you're about to choose. If unused for a period—say before food has been ordered the mouse pointer should become highly animated and fidgety in some way. Graphical concepts that can improve on a hand for the pointer may be used.

### Help

There is no Help, other than summoning a waiter (the ‘Call Waiter’ icon—see FIG. 1). If we are trying to have a device that anyone can use, and that assuages any fears they may have, and one that does not in any way remind you of using a computer, then having a Help icon (which would then undoubtedly caused the user to spend a large period of time ploughing through vast quantities of largely irrelevant material before summoning the waiter anyway) would cause more damage than good. We simply should not need this if we are basing the design around the normal restaurant experience, with some light controls for ambience. If there are individual features that do need their own help—The Quiz, say—then a Help icon can appear when they are active.

### Single Diners

We turn off the functionality of half of a table when a single diner is using a two person table. Remember that all table positions are inactive (in terms of interactivity) until the maitre d′ has turned that table on. The other half of the table is programmed to slot into the ambience choices of the single diner.

What Happens When the Customer Arrives at the Table

This section describes the layout and functionality before the customer has moved the track pad. And upon him first touching it. A section below describes these things once the track pad has been moved.

### Introductory Speech Upon Arrival

The waiter present asks the customer: “Have you been to inamo before madame?”. If the answer is yes, the waiter says “Excellent, I'll take you straight to your table” and that is the end of the matter.

If the answer is “No”, the waiter gives the customer the following speech:

“Well madame, we have a unique ordering process here—you don't order through a waiter but use this device (pointing to the track pad) to do everything. If you need any help, just press here (pointing to call waiter). One last thing, madame we recommend that everyone at your table places their own orders—you don't have to but everything works out nicer if you do.”

UI Functionality Upon arrival

The maitre d′ (or head waiter) informs the system that new customers have been seated at a table. The first thing the customer sees upon arrival at the table are projections clearly indicating which areas of the table are free for the customer to use, and which will be required for the UI. This will include 3 white spaces where the plates would arrive, 2 white spaces for glasses, and one white space for condiments. This is shown in FIG. 2. The dot from the inamo logo will slowly pulsate on and off the central plate

The UI will otherwise operate as it will later except that initially:
The LH space will have text saying “You can put your own things here” written on it.
The RH space will have amusing beautiful projections (‘animations’ in FIG. 2) on it, but ones which clearly do not require the customer to interact with them. The customer is unlikely to place objects in obvious areas of projection activity. The amusing/beautiful projections fade away upon the customer first moving his pointer with the track pad (see Section below on initial UI layout). The main options (food, drink, ambience etc.—see below) are visible before the customer moves his track pad and run along the top of the RH (as labelled in FIG. 1). When the customer uses the track pad, the pointer appears big and clear moving. The projections also do not just disappear but fade away over a period of 2.5 seconds. If the customer does not move his track pad for a period of 3 minutes, a message appears in RH replacing all the projections in RH saying “Move Me” with an arrow point directly to the track pad.

### The Plate Spaces

There are three bright white spaces on the table. The following options are possible for the look of the plate areas described above:
They could be perfectly white (This is our default option from above).
They could have a gradated blend from white into the overall table ambience.
They could be a different colour to white e.g. a warm yellow
We could initially project a virtual inamo plate/bowl onto these areas. This could be a 2D or 3D projected image of a plate. While the person is eating, one of the plane options would have to be used.

NB that all but the last two of these options apply to all of the plate areas (P1, P2 and P3) wherever they are used in this UI document.

### Initial UI Layout on the Table and Ordering

This section describes the layout and functionality after the customer has moved the track pad.

The main options available on the UI at the start of the meal will be:
Food.
Drinks.
Ambience.
Extras.
Call Waiter.
My Order.
Bill.

These options will be depicted graphically (as labelled in FIG. 1) with no text and will be instantly identifiable. The My Order and Bill options are ever present and if people press them before the system is ready, they simply explain their own use to the customer (note the discoverability of this method and see below).

There will be a white circular area directly in front of the customer where his central plate will sit. The main list of icons should prioritise our two key activities—ordering (both food and drink) and ambience (and contain our other major functions—“Call Waiter” if you need any help, and “Entertainment”). The My Order and Bill options only become fully active once someone has selected food items and placed their order (respectively). Until then, clicking on My Order will present large text saying “You have not yet selected any items. Items selected will appear here once you do. We like to start our meals with a drink.” Accordingly, clicking on Bill the text will say “You have not yet placed an order, your bill will appear here once you have done so. In both cases there will be a floating button option which says “OK” which functions in the same way as all floating button options. Pressing this button returns the customer to the main screen. The main icons should ideally be obvious enough in their form that the customer will immediately know what they represent or be willing to discover by selecting them.

For prototyping the hover functionality, hovering over the main icon will create an increasing glow which takes ½ a second to fully open that item.

The initial layout of the UI will make use of the areas labelled P1, P2, P3, D1 and RH (for display purposes only). Later on, when an order has been placed, the whole UI will function only in the area labelled RH. FIG. 3 depicts the labelling of the different areas.

For all applications in vl customers cannot interact with the left hand side of the UI at all: it is used for display purposes only. They will not be able to move the track pad pointer outside of the right hand UI (i.e. to the right of the dashed line; the dashed line itself will not itself be projected, although some way of marking the LH and RH zone boundaries may be useful.

### Searching Through the Food Menu

### Top Level Ordering

When the customer chooses to view the menu by selecting the ‘Food’ main icon (see FIG. 1), the main menu options (e.g. small dishes, large dishes, set menus, desserts) appear on the right-hand side of the table area, as shown in FIG. 4.

The ‘food menu’ options float around the right-hand area of the table surface and when a customer hovers over one of them, they all freeze and that option becomes highlighted. If the customer moves off the item, they all start floating about again. If a person hovers over an item for 5 seconds, without pressing it or moving off it, the text “press to see more” appears. When a hover is used as the selection mechanism, then the clicking stage would be excluded. If the mouse pointer was on the right hand edge of the screen when the items came in and it stopped the items, this may destroy the functionality. As such, the mouse pointer should auto relocate to the centre of the right hand UI upon each selection and none of the options should move straight over it. The pointer should also animate itself in some way so as to make it clear that it has relocated.

When the customer selects one of the ‘food menu’ options (e.g. large dishes), a box appears into which all of the other ‘food menu’ icons jump (e.g. small dishes, set menus, desserts). This box is clearly selectable. This box then moves to the top of the UI horizontally aligned with the food menu option in a fun and agile way where it will now sit as a title to the food items that will appear and float around below it and be a clear indication to the customer of how to step back in the ordering process. Pressing this button acts like clicking the ‘food menu’ icon and returns the customer to the previous options of small dishes, large dishes, desserts and set menus.

Having Selected Large Dishes, the Customer is Now Presented with a List of Large Dish Menu Items.

### Choosing a Large Dish

When the customer chooses to view one of the food menu options the appropriate menu items appear in the RH area.

Our customer has started ordering a main course. Little dishes float around on the right. They appear from the far right hand side of the table and float through the right-hand area of the table like a stream of liquid flowing slightly randomly and back around with flows and eddies. New dishes appear from the top right and disappear off the bottom right of the middle section. The whole menu is not displayed at any one time. The dishes float around and which ones are visible changes. The dishes could also just appear and disappear out of thin air after a specified and slightly randomised amount of time rather than floating in from the side. We could also incorporate these two forms of animation into one. The dishes float around in a pre-defined area. Every now and again one of the dishes starts to jiggle/fade and is replaced by another.

If you move the pointer (we have used a pointing hand, being less computer-based than an arrowhead) over one of the floating food items that item stops and is highlighted in some way with some information about the dish (to include a brief enticing description, and price subtly yet legibly displayed) and the text “Press to see more” appearing. While the other food items continue to move about it.

### Adding Some Food to Your Order

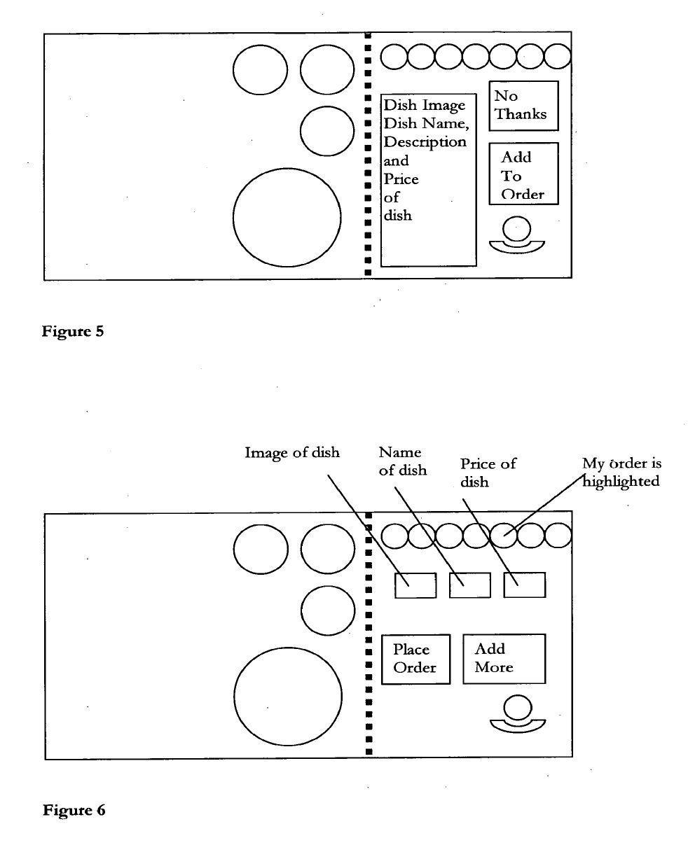

If you click to select a dish, as described above, the full description of this dish appears and the image of the dish is shown on the right-hand side of the table replacing the floating menu items. The options: “add to order” and “no thanks” are offered. Both of these options float around on the right hand side of the screen in the same manner as the food items did. The item is added to the customer's current order by clicking the ‘add to order’ option. FIG. 5 depicts this.

The following information about each dish will be displayed: Main ingredients, Allergy information (a small icon saying “Contains Nuts/dairy/gluten” and recognisable symbol on the left of that text if a dish contains nuts or dairy or gluten), price, a brief enticing description of the dish. The price should be shown subtly yet legibly. Box sizes and dish data field sizes should be defined such that the text descriptions of the dishes should always fit into the boxes.

The floating dishes reappear if the customer decides not to order this item. If the customer chooses to order the item then it is added to ‘my order’.

### My Order

You click something you're pointing at and add it to your order, as described above. The “my order” icon at the top of the screen is shown selected in some way, and the food and drink order so far is listed on the right-hand side of the table (smaller than originally shown, if necessary in order to fit the area). The left-hand area of the table displays large images of the contents of the order. Food items are displayed on the three plate areas. FIG. 6 shows this.

The first dish ordered appears directly in front of the customer (P1—see FIG. 3 for the position of this) and then additional food items fill up to the left (P2 and then P3). In the unusual situation where more than 3 food items have been ordered by a single customer one or more of the images will alternate which food item is being displayed so that the additional dishes can be observed. In this event, when the food arrives, it will arrive on a custom designed inamo plate holder which can house multiple plates. One of the dishes shown on the left becomes highlighted as does the description of this dish on the right hand side. Which dish (and description thereof) is highlighted rotates so that any one time, one of the dishes is highlighted

The customer is offered the options of ‘place my order’ and ‘add more to my order’. If he chooses to ‘place my order’ the order is sent through to the kitchen and the customer is presented with a new screen (see ‘What happens after pressing place my order’). If he chooses to ‘add more to my order’ then he is returned to the top level of the main food menu. If the customer selects a different main menu option to view this also replaces the ‘my order’ display without the customer having to make the choice between ‘place my order’ and ‘add to order’. To bring back ‘my order’ the customer has to click the ‘my order’ icon or when he adds another item to his order, it will reappear automatically. It should be obvious to the customer that selecting an item to add it to your order does not actually place the order.

Removing from the Order

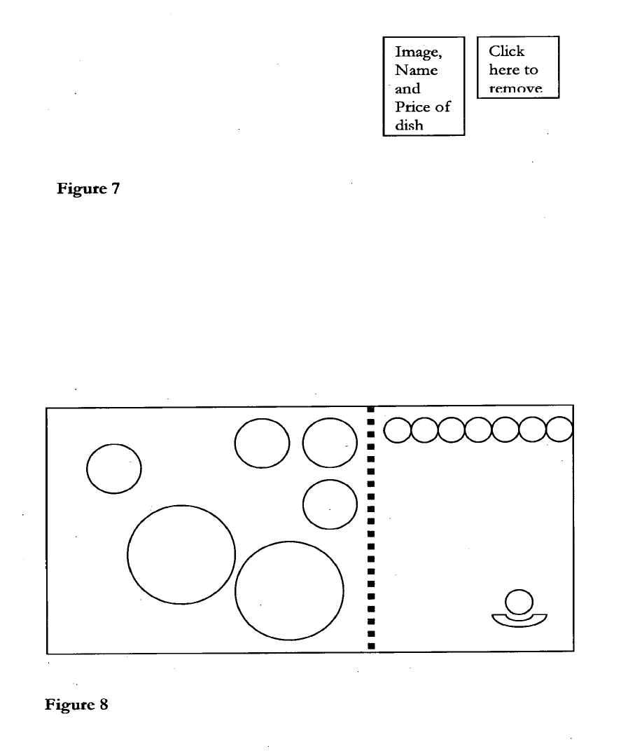

Point at the item you wish to remove on the right-hand UI area, and after ½ a second the option to remove it will appear on the side of the item, as shown in FIG. 7.

What Happens after Pressing ‘Place my Order’

The images of the ordered items which have accumulated on the left-hand side of the table gradually fade away over a period of a few minutes into white spaces (see below)—so that the table space to be allocated to the dishes is defined, and the image fades in time for the meal to be delivered. Text also appears and lingers telling the customer that their order has been placed and letting her know that she can order the bill when she is ready to pay by pressing the bill button. When the order has been placed, depending upon how many items the customer has ordered, the UI adapts to allow space for them by creating an appropriate number of white areas on the table. All remaining areas are used in the table ambience. The waiter can then place the dishes in these predefined areas—and this will ensure that the food is not having ambience or images projected over it when it arrives. An extension of this is that if the customer has ordered a curry dish, for example, which is accompanied by a small bowl of rice, the UI reflects a circular area or diameter 16 cm dish/bowl, and a smaller 10 cm diameter circle for the rice bowl.

The example in FIG. 8 shows a table ready to be served with one large dish, one small dish and rice ordered by the customer. Note that the large dish and the small dish occupy containers of the same diameter.

### The Plate Areas

For clarity, here is the order of the number of plate areas presented on screen as the customer goes through the ordering process:

| | |
|---|---|
| When sitting down: | P3 (Upon moving the track |
| | pad, this fades to 1 →) |
| After having first moved the track pad: | P1 |
| In drinks ordering: | P1 |
| In food ordering: | P1 (Until they select an item |
| | which →) |
| In My Order | P1 (Increases up to three as |
| | they add items →) |
| After placing order | Depends on order (can include |
| | smaller rice bowls etc.) |

### The Drinks Menu

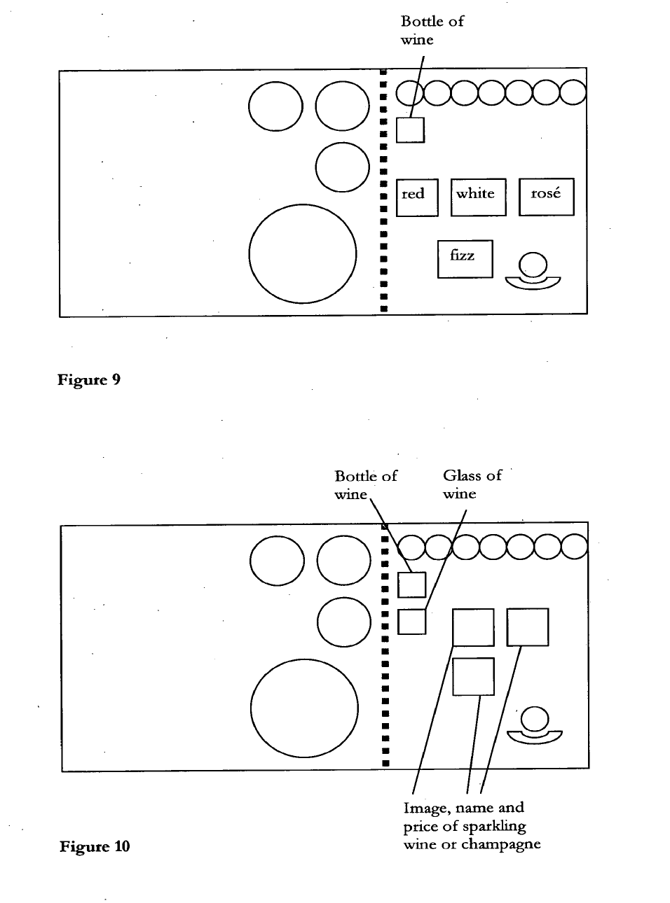

The drinks menu options appear on the right-hand side of the table as the food menu options do above. When a selection is made from the options above, the main drinks menu options pack up into a box and move to sit below the drinks icon in the same manner as the food options did. Selecting the box takes the customer back to the menu options pictured above as with the food menu. The customer selects wine by the bottle and a sub menu appears with the options “Red, White, Rosé, Fizz” and rotates displaying in the middle of the right-hand side of the table, as shown in FIG. 9.

Hovering over one of the options freezes that option. No text explanation occurs. The customer then selects to view ‘fizz’ and the ‘wine by the bottle’ option packs up into a box appearing below the main drinks menu options icon as before. The champagne menu items now appear on the right-hand side of the table, as shown in FIG. 10.

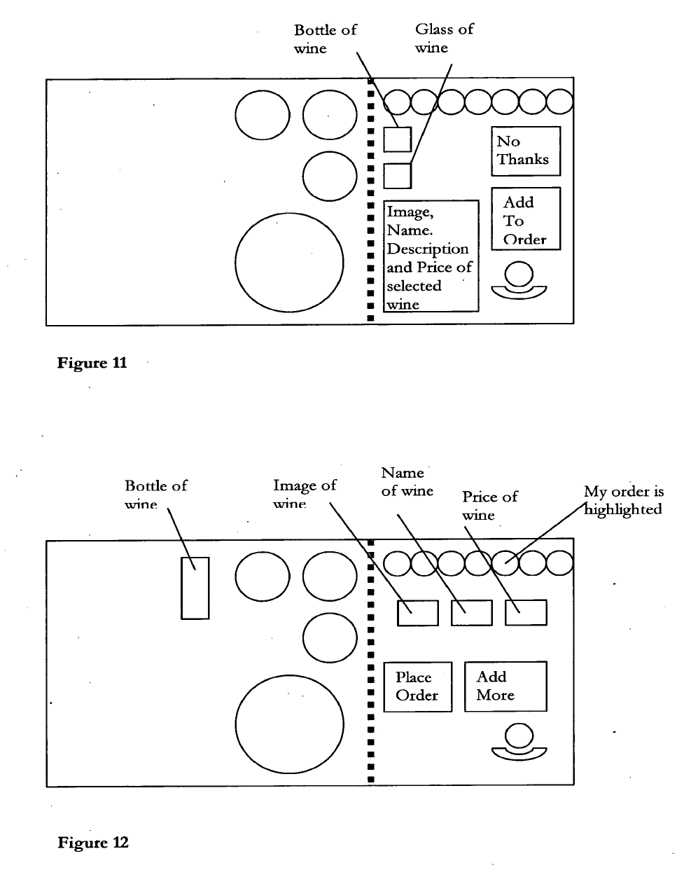

The individual drinks items behave exactly like the individual food items here—in that hovering over one freezes it with information displayed (see FIG. 11) and clicking selects it.

If the customer chooses not to add the item to his order then he is returned to the last viewed section of the drinks menu. If the customer chooses to order the item then ‘my order’ is displayed as it was with the food, and the image of the drinks item added to the order appearing in the area above the central plate and to the left of the glasses (only before any food items have been ordered), as shown in FIG. 12.

If the customer adds more than one drink item to his order then the image on the left hand side of the table, to the left of the glassware, will fade in and out of the selections made. If the customer chooses to place his order, the image of the ordered drinks item fades away, as with his food, the customer is then presented with the screen as described above on what happens after placing his order.

Note that the text telling the customer that his drink had been ordered would also direct her towards ordering some food. Saying “Thank you! Your drinks order has been placed. After a nice drink, we like to order a hearty meal. Two small dishes and a larger dish are usually enough for us but if you're really hungry, maybe order three large dishes.”

### Option: Drinks and Food on the Same Menu

Note that it is perfectly possible, if a particular restaurant desires it, for drinks to appear on the one menu with the food.

### Replacing Items

I have changed my mind about my main course
I want more than one side-dish
I want to replace a side-dish
Changed my mind—I want to go back to a previous choice

For inamo, with its almost tapas-style dishes, the adding and replacing interface is very straightforward: you pick things on the menu to add, and if you go to “my order” and hover you'll see “>Click to remove<”. There is no replacing.

For Restaurants Other than Inamo

For other, more conventional restaurants, replacing may occur when items are ordered:

If you click on a main dish on the menu (starter, main or dessert) it would replace any previous selection.

Each main would have a list of side dishes with which it almost certainly would not be ordered with—for example, a pasta dish would have any potato side dish on this list. When a main dish goes onto the plate it automatically expels any such side dishes from the plate. (In the spectacularly rare situation that the side dish was still wanted—mash with pasta, say—the customer can just click it again on the menu to put it back. It's only when you change the main selection that mismatches are considered.)

### One-Click Ordering of Drinks?

It may be possible, when ordering drinks, to just find a drink and then submit it as your order immediately, rather than going through the two stages of “add to order” and “place my order”. And in perhaps eight or nine out of ten occurrences that is useful, but even then, this may not be enough, as it has to be easy to work out how to order drinks for yourself and for somebody else—e.g. for a child, or simply because your partner is a bit of a technophobe, and you are doing all the ordering at your end.

### If There's Doubt About an Item, Let it be Changed

if, say, you order Orange Juice, did you want ice?

It will appear on “My order” in its most likely state, eg with ice, and with some way to remove the ice.

### Non-Usual Choices

“Call waiter” (described below) is the most useful thing. Waiters remain a major part of the experience too, still, despite the technology involved. One of the design principles mentioned is that we should not try to swamp the interface with options for every possible rarely-encountered situation. So, it should be very clear at all times how to call a waiter, and it should also be clear that that is what a person should do for any problem such as the situations outlined above, rather than frantically clicking everywhere on the screen to see if there is some hidden option to do what they want.

The Call Waiter option on the main UI.

Upon pressing the call waiter button, the customer will be presented with an option to confirm that they wish to call the waiter over. If the customer confirms he wished to press the call waiter button, a message is shown to say: “A waiter has been called.” All of the inactive part of the table glows a certain warm colour for a period of 10 seconds. The message fades away over this period.

I want to order TWO main dishes for myself
I wanted to change my order! Is there time?
I would like a fork instead of chopsticks
I need a knife
I'd like my starter to come with my friends' mains. (It's all I'm having.)
Can I have a particular starter as a main?

For v1, these are all “call the waiter” issues.
Can I have that one but without the chilli?

Again, for vl not an issue.

It is not too hard to imagine how this might be done: when the description of a dish is shown, listing the ingredients, you can just have another pointer over the ingredient concerned (as long as it is one of the ingredients which can be “customise”—typically chilli, garlic—they would probably be indicated), and e.g. a small set of choices pops up—eg:
No chilli
Chefs call
Lots of chilli!
Too much chilli!!
Option: There could be a physical call waiter button on the track-pad as an alternative to the call waiter button on the interface. This could clear up space on the UI and simplify it too

### Set Menus

Set menus will be accessible from the food menu. There should be a maximum of four set menus (one of which should be vegetarian, one of which will be a fair trade set menu). Set menus should represent our best value food. The top level functionality of the set menus should be the same as that of the main food menu once small dishes, say, has been selected. If the customer selects one of the set menus, images of the dishes on that set menu appear in sequence on the right-hand area of the UI with an accompanying description exactly as an individual food item would appear.

A short description of the set menu as a whole and a list of the dishes, and a price will also appear. To add a set menu to an order the customer will click ‘add to order’ which will appear alongside ‘no thanks’ when viewing the set menu has been selected as with the small dishes menu. As the image of each dish is displayed the appropriate name of the dish will be highlighted and glow in the description of the set menu.

### Ambience

We will set different default ambience settings for each table to create a tapestry of colour. In future versions, we may want each place setting to have a different look and feel selected when the customer arrives that goes beyond this with different animations or skins etc.

### Skinning

For version 1.0, a single skin will be developed. In the future, we will require multiple skins. At the time we require multiple skins, you will be able to choose a look & feel for the table, from several:
Skins should cover different commonly-held views of what is cool and stylish.
But at the same time, none of the skins should, by their look or even potentially by their existence/name, affect the overall “cool and stylish” feel of the restaurant to any significant number of customers.
Seasonal skins (or backgrounds) e.g. for Winter/Christmas, Valentine's Day could be introduced.

### Using the Ambience Controls

The ambience element of the software will function in a similar way to the main ordering screens, with rotating options when necessary. Upon selecting ambience the customer will be presented with two floating options that he can select from. In version 1.0, the options are:
Colours
   The colours take the form of a colour spectrum (e.g. RGB) which are constantly circling around similarly to the menu items (hovering over the colour offers the option of “more” and “less” which can both be pressed).
I've just changed the colour on my table and I want to order some food but I fear that pressing food will undo everything I've done.
I've just changed the colour of my table and I hate it. I want to go back to how it was.
   The option ‘Done’ should also float about with the RGB colours and if the customer selects this he is returned to the main screen with the current colour settings. There will be one final option which will be the return to default option but this will not be presented as text. Instead this will be a floating picture of the table as it was before the customer pressed anything. Pressing this button resets the table colour.

NOTE: The customer does not need to press done. The system will be statefull and she can simply jump about the UI by pressing food or drink or extras. The done option is there so that the customer can feel they have completed their task and that they understand the ordering process.
Alternatively we could offer several sliding scales of colour. NOTE: The functionality of these two options is in essence the same—the customer is just deciding upon the amount of red, green and blue.
In the hover to select version of this, moving the cursor to hover over the blue, for example, brings up the up and down arrows, moving over increase, for example, pulsates the blue colour up one notch every ½ second.
Wallpapers—(We will call them Tablecloths).
The Tablecloths will be in a variety of different patterns which float around like menu items. If you hover over one it will hold and give a preview of this tablecloth which lasts until the customer moves off. As with the colours the done and default options will be available in an identical fashion to how they are in that section.

With the floating items in food, all the items come in and out of view. Unlike the food items, in this case, the default and done options must always be in view and all the other floating options can come in and out of view.

I'm hovering over this tablecloth and my table is showing it—but every time I move off it, my table cloth goes away—why? By association with the rest of the UI the customer should know to click through in order to make things happen but in case he doesn't, if the customer stays on that tablecloth and does not select it for a period of 5 seconds, encouraging text appears which says “Press to select this tablecloth”. In the hover to select version of this, moving the cursor to hover over a tablecloth both previews the tablecloth and brings up text on the side of the icon which says “hover here to select”. We can introduce some nice vibes through very thoughtful phraseology here. Rather than “done”, it could say something like “Choose me”. We could also be slightly cheeky by messaging the customer with little statements like “A fine choice” or “Looking Great!” The message you get could even depend upon what colour setting the customer has chosen and could be combined with a random element so that doing the same thing doesn't always yield the same message. For example if the customer tried to put the palette towards an unpleasant pinky colour, the message could read “An interesting choice madame . . . ”

Future versions of the software may include
Design your own table
   Paint style program with a small selection of fun tools to allow you to decorate your table in a fun way.
   We'd have to think very carefully about the best tools to offer for ease of use. There could be simple tools such as spray can, shapes, marker pen (for writing messages); alongside styles to apply, e.g. graffiti, renaissance, etc.
      We would wish to have this program looking nothing like paint, but utilising amusing custom tools—speak to Dan Brown, and the like.
Music—either
   Entirely customisable music for each individual or table with an extensive track listing.
   Changeable channels of music associated with moods or genres, e.g. classical, jazz, electro, rock, pop, etc, which the customer can select from. Giving us control over what style of music can be played and when.
   If speaker expense proves prohibitive to customisable music then we may wish to simply tell the customer what is currently playing on the restaurant stereo system.
   Normal restaurant-wide music system, with speakers housed in the projector node ceiling mountings—no interaction with the UI.

### Bill/Cost

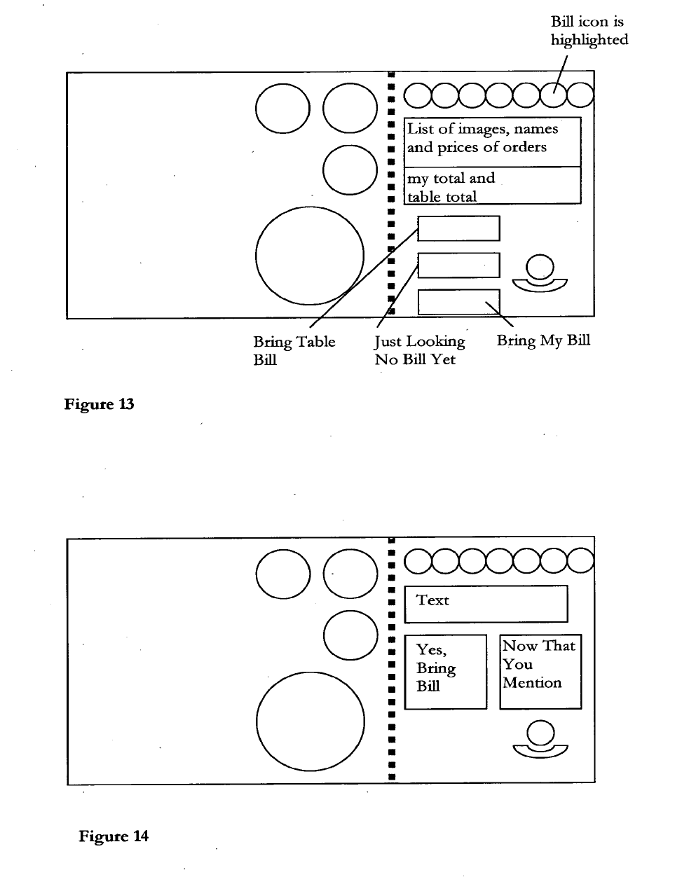

There will be some easy to understand icon in the main list of icons (given as ‘Bill’ in FIG. 1), for viewing and requesting the bill. The customer will be presented with a list of the items that he has ordered to include small pictures of these items and a price for each as well as a total spend amount for the table, as shown in FIG. 13.

One of the benefits of having an automated ordering system that keeps track of what every individual is doing is that when it comes to the billing stage of a meal everyone should be able to find out exactly what they have ordered, to remove any payment arguments or queries. They will be able to do this in our restaurant when the printed bill arrives, as the printed bill will be split into each individual seated at the table.

The customer will be presented with three options which all float in from the right underneath the bill in the normal selection fashion. These options are:
Bring Table Bill (Emphasized significantly above Bring my bill in some way)
Bring My Bill
I'm just looking, I don't want the bill yet.

This alters for a single diner (i.e. is it just ‘Bring My Bill’ or “I'm just looking”).

What Happens when One of the Bill Options is Requested?

Pressing the “Bring Table Bill” option will take the customer to a confirmation screen on the RH of the UI. The rest of the table will continue to look as before. On this screen the customer will be presented with text saying “If you request the bill now, you will not be able to order more food and drink—are you sure you are done ordering?” Two options will float around these are “Yes I want the waiter to bring my bill” and “Now that you mention it, I might grab a coffee”—as shown in FIG. 14.

It is a requirement that the bill is delivered within 3 minutes of the button being pressed.

If instead of pressing “Bring Table Bill” the customer pressed “Bring My Bill” then the same will happen but the text the customer will be presented with will be “This option orders the bill just for you separately from the rest of the diners at your table—this is mainly for people who are leaving early in a meal. Are you sure you want to do this?” And the floating options available are “YES I'd like my share of the bill” and “Oops NO—That's not what I meant to do.”

When the “Bring Table Bill” or “Bring My Bill” button has been pressed and confirmed the appropriate waiter will be paged on his PDA to attend to the bill. The table UI (either for just the customer or for the whole group depending on which option the customer chose) will momentarily glow another colour to show that the customer's request has been received and a message will inform the customer that a waiter is on his way saying “Your request for the bill has been noted and a waiter will be with you shortly”. The customer will also be informed that ordering facilities for [her/her table] have now been disabled (see below). If instead the customer chose not to confirm in either case, the customer is returned to a blank main screen just as if she had pressed the “I'm just looking, I don't want the bill yet” option.

### After the Waiter Delivers the Bill

It is a requirement that the waiter will return to a customer's table within 3 minutes after delivering the bill in order to take payment for it.
I've ordered my bill and it's been delivered but I'm ready to pay, the waiter's nowhere to be seen. How do I leave??!!!

If the customer has used the call waiter option before, it should be obvious that this is an option again and that this is how he should deal with this situation.

Option 1: We could have a ‘collect the bill’ option as well, so that the customers have time to sort out who's paying what and how, having requested the bill. This seems fiddly. The waiter could inform the customers to press the ‘collect my bill’ option when they're ready.

Option 2: The waiter can merely give them a moment or two as in an ordinary restaurant, he is now aware that they're ready to pay. Often the delay for paying the bill in an ordinary restaurant is caused by this part of the process.

Option 3: The waiter could hang around while the customers sort out their bill payment.

Changes in UI Functionality when the Bill has Been Requested

If everyone wants to pay then food and drink ordering facilities for all will be disabled. If a ‘bring my bill’ request has been made then only the individual who's leaving will have his ordering facilities disabled.

We leave other table functions active so that the customer can play around with them while waiting (the hopefully very short period) for his bill.

### “Local Info”/“Fun”/Extras

Included in version 1.0:
Webcam pictures of the kitchen (the presentation, not preparation areas). (Preparation areas involve a great deal of chopping things up that you might not want to see chopped up.)
Restaurant tour—a virtual guide to inamo.
Where are the toilets?—although this might be part of the Restaurant tour
A small and fun applet/game
Taxi!
Local bars etc

### “Encouragement”

### When we Want to Encourage People to Hurry Up

When people sit down at any restaurant table, they inevitably chat away. Maybe they start looking at the menus; maybe one or two people do come to some kind of decision about something; but typically, they carry on chatting. At some point a waiter comes round and says “can I take your drinks order?” and they hurriedly make a choice, or say “sorry, can we just have one more minute?”

The above situation alone would be bad enough in a one-hour turnaround restaurant, but things are going to be much worse if you are relying on them to do the ordering themselves via some interface.

I've Been Sat Here for Half an Hour. Why has no Waiter Come Along to Take my Order?

Upon being seated at the restaurant, it is a requirement that it has been explained to the customer that he will have to order food using the system. The encouragement process is dynamic. If our restaurant is only half full it is better for us if the customer stays for longer, buying more things and making the restaurant more full. If we are overflowing and have many people waiting for a table or we are turning people away then we should try and chivvy people along (i.e. encourage people) to leave. Note that as such the time periods given below apply to a fairly full restaurant during peak hours and to our prototype. The time between a person ordering nothing and being chivvied along will depend upon the time of day and will be created using a carefully sculpted algorithm. For now we will use only the exact times given. The system may be able to identify the number of seated diners in our restaurant and automatically adjust whether the chivvying facilities are enabled or disabled. We should build elements of this encouragement process into the system, but also leave some of it (at least in version 1) to the members of staff such as waiters, maitre d′ and manager, as is the case in a standard restaurant.

### Methods of Encouragement

Ways of Encouraging the Customer to Proceed with the Ordering Process

The maitre d′ or waiter will have acknowledged someone's presence at a table on the POS system when they have been seated. If the customer has not touched the track-pad for a period of 5 minutes following this then the system should prompt the user into ordering something. This could be achieved in several ways: The UI will begin to become more animated, and the appropriate icons become more animated and/or flash. First of all, the drinks icon starts to get more animated and simultaneously some pictures of the available drinks in the space reserved for drinks in the my order screen are shown.

Once the customer has ordered drinks, the food icon becomes animated and images of certain food items appear in the food place at random. If after a lot of increased animation and 10 further minutes of waiting, the customer is still not ordering any food, the system starts to self run in a demonstration of how to go through the ordering process.

Ways of Encouraging the Customer to Proceed with the Billing Process

When there have been no orders on the system for 25 minutes, text comes up on the right hand UI saying “Can we get you anything else—drinks? Food? Just the bill? After 45 minutes of no orders the bill icon starts to become very animated and agitated.

Interaction with Other Tables

Whether or not you can “Send flowers” to the person you're sitting with, and have them appear on their side . . . why not send flowers to that person at that table over there who you happen to think is attractive? And similarly, why not be able to ask “what is that this that they have over there?” Note that the Table Management Software can handle the various possible table arrangements, so that it would be possible always to display on the screen the correct current map of which tables are where.

### “Fun” Section: Things in Involving the Outside World

News, Sport . . .

Shopping.

### Camera, eg to Detect the State of the “Table Area”

If the overhead projection system incorporated a cheap camera then software could check the state of the “table area”, for both customers, testing whether it was still largely the same basic tablecloth colour, and would know if the area was obstructed or clear or not, and could thus decide whether to use the area or not for icons, images etc. that the customer needs to be able to read or interact with. If there are intrusions into the area, but the area is still largely usable, then the area around the intrusion could be used. If you were to have a camera in the overhead projector, then the software could intelligently choose a route around the service of the table when “delivering” presents, the present navigating its way around glasses, dishes, phones, etc to its destination.

### Sending Presents to Your Partner

### Virtual Presents

The customer can choose virtual presents, to send across the table. They could be in the form of flowers and realistic gifts, and/or fantastical ridiculous gifts (e.g. a pet inamo dragon which the recipient could stroke and then it disappears in a puff of smoke). We might have to limit the number of virtual gifts that a customer can give per meal. These gifts should probably appear on the left hand area of the recipient's table so as not to disturb the rest of their UI experience. They will fade away after a short period, or after a necessary piece of interaction by the recipient. Alternatively by hovering over the flowers, say, the customer could be given the option of putting them in a vase on that area of the table. There would have to be a remove function for later on. The customer can only have one gift at a time on the table. We could give one virtual gift free and charge a small premium for later ones.

### Real Presents

The customer chooses real presents, specifically flowers and chocolates to send across the table. This is a surprise for the recipient. It should not be obvious what the giver was preparing to do. We could constantly adapt and improve the gifts available. These gifts would either have to be readily available, preservable, and easily storable OR not too expensive to acquire and not stored in large numbers at any one time. The cost of the gift would simply be added to the bill.

### Ambience—Basic Workings

NB For Hovers Over, Read Either “Hovers Over” OR “Taps on”

The customer hovers over the ambience icon. Three options appear in the same manner as the food options. These options are: Table Colours, Tablecloths & Table Moods. The options themselves are small animated graphics indicating their purpose. There could be coloured and animated text, bursting out of the option bubble in which is it enclosed. They drop down from the ‘ambience’ icon. When one of the options is hovered over, it opens. The option to step back to the previous screen is offered as before in browsing the food menu by the hierarchical structure of a sub-heading bubble.

### Ambience Scope and Defaults

### Ambience Scope

Alterations to the ambience affect the whole table—not just the users' half. The selection of reflectionally symmetric images will likely be preferable—at the very least, images with no clear orientation.

### The Default Setting

Each table has a default setting which is a plain colour and is different from table to table (settable by the restaurant.) The option to return to this setting must be available to customers and one of the options in each of the three ambience modes must be the default option—even if it is not titled as such.

### Table Colours

The customer uses a colour circle to select the table colour. The colours could be chosen in the same manner as menu items, but it may be better to have the more fun rather than functional areas of the system operating in a different way.

The table colour changes according to which colour is under the cursor. To select a colour the customer has to tap on a ‘choose me’ button. When a selection has been made the customer is returned to a blank right hand UI. Unlike here, with the proceeding section on Table Cloths, there is no automatic preview upon hover. This is partly because of the time it may take to load an image as opposed to a colour wash. The customer here is returned to a blank right hand UI upon selection and there is hence no need for any kind of exit button.

The colours could change and blend in and out of each other upon roll over.
The colour wheel enters with a nice circular spinning animation.
A customer is only allowed to choose pleasant colours and there is a selection of at least 15 colours on the wheel to choose from.
There is a button in the centre of the wheel titled “SPIN” which makes the colour wheel spin around and presents the customer with a second set of colour options (there are only two sets of colour options).

The button in the centre of the wheel could be a randomise button which selects a random colour instead of a spin button. The button in the centre of the wheel could be a default button which returns the table colour to default.

### Table Cloths

A tapestry of different images and patterns appears—a chess board of different options. These options shift around every once in a while, like one of those puzzles where you have to reorient the pieces to make the overall picture. New options come in and present themselves to the customer every once in a while replacing the old options. The default (blank) table cloth is always available to the customer.

While the other options continue to slide around in the background. (this selection process could be adapted for the colour selection too).

When a selection has been made the whole table displays the image and the customer is returned to the above screen.

OK I've selected my table cloth but everything's still displaying—how do I get out? At all times on this screen there is also an exit button titled “Leave with this table cloth” (Lexicon TBS) underneath the tapestry of wallpaper options. The customer does not need to press this button as she can simply move over food and the display will disappear. After selecting the table cloth, the customer could be returned to a blank right hand screen but if the tablecloths are not previewing automatically upon being hovered over, each customer would likely wish to preview several different table cloths.

The table cloth could also be previewed—across the table previews of table cloths could be within their own circles.

### Ideas for Table Cloth Images:

Customised celebrity images.
Artwork from up coming artists who we could source via various institutions and foundations.
Famous images from around the world—Mona Lisa, Creation, Daffodils, Water Lily Pond, Café Terrace at Place de Forum, Icarus, etc.
Possible difficulties in orienting the images in a manner where their subject matter can be seen around the plate area, etc. Might have to tile the images. It is possible that each image's position will have to be individually customised to make sure it displays properly.
These table cloths should be updated, or a database of them rotated, at regular intervals.
We need to consider symmetry of image viewing by seated parties.

### Table Moods or Themes

These could be presented in the form of icons that represent the mood to be created, e.g. love heart for ‘romantic’, a graffiti scrawled wall for ‘street’, etc.

When each option is hovered over, a bigger preview is shown on the table with a ‘choose me’ button. When the ‘choose me’ button is selected, the whole table is covered. As with the table cloths, there is also the option for these to preview over the whole table when being hovered over.

Once the customer has selected their table cloth, everything is still displaying—how does he get out? At all times on this screen there is also an exit button titled “Leave with this mood” available in the bottom right of the UI. The customer does not need to press this button as he can simply move over food and the display will disappear. All of the ambience options could also appear simultaneously in the right hand UI area. They could be miniaturised and then magnified and animated when hovered over. This option does not perhaps give the same level of exciting discoverability as the above (albeit this may not matter), and there would probably not be enough space to show all three options simultaneously and do their functionality justice.

### Extras

The customer hovers over the ‘extras’ icon (see FIG. 1). Five options appear in the same manner as the food options. These options are: Chef Cam, What next?, Play with me, Inside Inamo, Take me home.

When hovering over an icon, a pop-up tappable button will appear on the upper-right corner which must be tapped to open the rest of the contents (in the same manner as food and drink ordering). Short explanatory text will also appear below each icon upon hover-over to provide details of what is contained in each section. A tappable button to open each of these options could appear only on ‘chef cam’ and ‘what next?’ as these are the only two of these choices which actually require immediate loading—the others go on to offer other options in a drop down format and could operate upon rollover.

As with the Ambience menus the options do not stack up in the same manner as the food and drink menu options do (e.g. ‘white’ and ‘wine by the glass’ both attach themselves to the drinks icon). This is to conserve space and keep the screens as clear as possible as they may otherwise become too busy.

Because we do not wish customers to rollover the icons and stall the system while the mini-program loads, a button tap will have to confirm that they wish to view each of the Extras sections. This would be intuitive in following the behaviour of other areas of the menu, and would mean that the system was behaving consistently.

### Chef Cam

When the customer hovers over this icon a brief description appears below it, and the option to open the applet pops up next to it as described above:

The text reads:

“Take a sneak peek behind the scenes at inamo with our chef-cam, see the meticulous and delicate preparation that goes into every dish. And, no, that wasn't your California roll that chef just dropped on the floor . . . ”
Option 1: Chef-cam—take a look behind the scenes at inamo via our virtual open kitchen—all sparkling surfaces and freshly prepared chow/fodder/grub/nosh/etc.
Option 2: Coolio once asked—“What's going on in the kitchen”. Here's your chance to find out. Take a look behind the scenes at inamo via our virtual open kitchen.
Option 3: “What's going on in the kitchen?”, as Coolio enquired in ‘Gangsta's Paradise’. Take a look behind the scenes at inamo via our virtual open kitchen.

Upon selecting to view the chef-cam, a simple movie player pops up on the right hand UI area. The display on the right hand UI looks like a kitchen swing door which swings open before the movie starts. We could also potentially have the video image centrally in the plate area, like a porthole into the kitchen, almost as though looking through a window in the kitchen door.

To close the chef-cam the customer would simply navigate away from the chef-cam page. There could also be an ‘exit’ button below the chef-cam window instead, which returns the user to a blank UI. This button would be styled in the manner of an exit sign from a building. If the chef-cam is not interacted with for more than a set period it could automatically close and return to a blank UI. The problem with this is that someone might wish to watch the kitchen for an extended period.

The length of the interval without interaction which precipitates the system going into sleep mode has still to be determined. It may be necessary to extend this period in the case of the chef-cam and the games, or even disable the functionality (just for the chef-cams or indeed entirely).

The customer may need to be made aware that navigation away from this page will close the player. Ideas for the icon image: A chef pictured on TV. A web-cam and chef's hat/knife and chopping board/food being chopped.

The functionality of this feature has been based on the premise that we can't have the chef-cam or any additional applets functioning simultaneously with normal menu interaction due to problems with physical space and memory usage. If this proves not to be the case, however, then the chef-cam could display either centrally on the plate-area, on the top-left hand side of the table, or perhaps tucked into the right-hand UI area in such a manner that the customer can still browse the main menu options without exiting chef-cam. In this case there would need to be a button which pops up in the right-hand UI area which closes the chef-cam, as the left-hand and central areas of the table are of course not able to be interacted with, or entered with the cursor (although there may be exceptions to this rule further down the line).

### What Next?

When the ‘view me’ button is tapped a small selection of currently featured venues/activities is displayed.

The featured venues display on a map, as glowing hotspots. When a hotspot is hovered over a pop-up box showing an image of the venue and text details appears, and vanishes when the cursor is moved away. We offer the opportunity to be put on guest lists for certain bars/clubs—this is in the form of a tappable button and appears on the display for each applicable venue. Upon the guest list being selected, the Maitre D′ is then paged. The maitre d′ will then come to the table to ask how many people the customer would like to be added to the guest list.

In order to navigate away from this page, the customer merely selects a different main option. The map could be scrollable if necessary although this is definitely to be avoided if at all possible. The scroll buttons would appear in a cluster of four directional arrows in the bottom right hand corner of the map. This mode of display could be restrictive in only allowing specific places to be highlighted rather than deals and offers. It might also be quite complicated to create, change and update. The scale of the map could also constrict the venues we can feature.

The content of the ‘What's next’ should likely be along the lines of cinema, theatre, clubs, and other attractions where customers may want to continue their evening's frivolity!

There could also be an ‘I've seen enough here—I'm happy at inamo!’ button at the bottom of the map area (probably only necessary if the system doesn't go to sleep, and never automatically reverts to a blank UI).

Ideas for icons—alternating graphics, e.g. a flickering cinema screen, theatre curtain being drawn back, ‘CLUB’ in light bulb style lettering, etc. Arrows, question marks, etc, implying an unknown future destination. The venues could also be displayed in bubbles rising up the page. As you hover over each one, it stops and enlarges to make the details displayed on it more visible and the others continue to rise around it. When they reach the top of the page they disappear reappearing at the bottom of the page. The bubbles approach could be applied to several of the other Extras menu options as a display or selection method.

The venues/activities could display one by one on the right hand UI, gently fading from one into another. There could be scroll right and left buttons. The venues could also display in a similar manner to the selection of table cloths in a quilt of smaller moving patches, which zoom up to display more details when hovered over.

This could also be subcategorised into genres. The top level i.e. ‘where next’ could operate on roll-over (as it will not load anything, rather only prompt the options below to appear). Rolling over this icon will display the following:
Bars/Clubs (Pubs too?)
Theatre/Film
Shops
Etc. . . —we should have the facility to add additional categories easily here, for special offers, etc. Details of things like health clubs, etc, we could arrange some contra deals here no doubt, we feature places in this section in exchange for free publicity from them.

These options drop down from the main icon in the same manner as the drinks menu secondary sub-categories (e.g. white, red, fizz, etc) fall from the main sub-categories (wine, beer, soft drink, etc).

The functionality continues in the same manner as the food/drinks menus—icons for the featured venues drop down from the bars/clubs, theatre/film, etc, options listed above, and display like menu items. When each possible venue is hovered over a pop-up ‘view me’ button appears like the ‘order me’ button on food menu items. When the ‘view me’ button is tapped the details of the venue display on the right hand UI, with simple webpage (html style) display of the details. It should be simple for us to update and alter the contents. The details could preview in a similar form to the food/drinks previews.

The buttons for each venue could either be simply text, or there could be a small image of the venue, or perhaps the lettering on the button could be in keeping with the logo/branding of the venue.

In order for the customer to navigate away from the display of the details they can either select any of the main icons, go back to the subcategory (e.g. Bars/Clubs, ‘name of venue’—which will be grouped next to the ‘Extras’ icon—cf food and drinks menu functionality), or presumably select a ‘close me’/‘finished’/‘read it’/etc . . . button.

Alternatively, when the customer has selected to view Bars/Clubs, etc, all the venues in that category display one at a time on the right hand UI area. The user taps/hovers on scroll/arrow buttons to cycle between the different venues featured. This may solve a possible problem of having too many sub-categories in this particular branch of the system. We could even decide that the details should simply appear upon rollover of the button for each venue in the same manner as a food menu item. An image with a small amount of accompanying text may well be enough.

Play with Me

The selection of games functions in a very similar manner to the selection of food and drink items. The games on offer drop down from the ‘play with me’ icon. When each is hovered over a ‘play me’ button appears on the top right corner of the bubble which must be tapped to launch the game. Short explanatory text will also appear in a box which fades in below each icon upon hover-over to provide details of the game and how it is played.

When launched, the games function in a demarcated section on the right hand UI area. There is a button in the bottom right hand corner of the gaming area for the customer to return to a blank UI. The games featured will be along the lines of E.g. Slidable game featuring inamo logo, Memory game with the inamo dishes.

The text on the button could be playful and change its wording—e.g. ‘cease this tomfoolery’, ‘enough of this frippery’, etc. Instead of text, as with the ‘Exit’ button on the chef-cam we could find an appropriate graphically themed button to perform the close and return to blank UI functionality.

If we featured Dan Brown style games, which often have no definite end and are more artistic than end based, the game could continue to ‘play’ indefinitely. To stop this, if the game is not interacted with for more than 1 minute 30 seconds it automatically closes and returns to a blank UI. This could also provide limitations on the style of game we are able to use.

Any games must be well suited to trackpad interaction. This probably requires something needing a fairly small amount of motion on the customer's behalf. A quiz game may be suitable. In the ambience menus we have not had a secondary sub-heading bubble appear below the main icon when exploring the ‘colours’, ‘moods’ or ‘table cloths’. This was due to the fact that the menu was only one level deep, and the main icon and any sub-heading bubble would have taken the customer to the same place. For the sake of consistency of user interface we may be better off maintaining the hierarchical structure.

The games display in bubbles rising up the page. As you catch each one it stops and zooms up and the others continue to rise around it. When they reach the top of the page they disappear reappearing at the bottom of the page. When each is hovered over and its motion stops, a ‘play me’ button appears on the top right corner of the bubble which must be tapped to launch the game.

The games appear in square format with a graphic in the top centre of each square (this graphic could fade in and out of different ‘screenshots’) and explanatory text on the right—as the cursor is hovered over each they ‘zoom up’ and a ‘play me’ button appears when a game is zoomed up and this is tapped to launch in the same manner as an ‘order me’ button on the food menu. The choices could also display in drop down bubbles from the main icon in the same manner as the drinks menu secondary sub-categories.

Ideas for icons—gently animated graphic reflecting one or more of the games offered. There are simple images which are iconic with the game genre (e.g. Pacman, a chess piece).

As the games are intended to be a short distraction and not a dominant element of the inamo experience the simpler option of stateless operation is likely to be preferable. In which case we should ensure that we only include short games which can be quickly digested, played, finished with. If we are to have stateless operation we may need to warn the customer that moving away from the current page would lose their current game—particularly if we are using a rollover to select functionality on the main menu options.

The system could be stateful and the game would pause and be able to be continued from where the customer left off if they are mid-game, browse other areas of the system, and then return to the appropriate game.

### Inside Inamo/Inamo Info

Upon the customer selecting the inside inamo icon three options drop down in the same manner as the drinks menu secondary sub-categories (e.g. white, red, fizz, etc). These options are: Restaurant Tour, Meet your waiters, About us. A ‘view me’ button pops up on each of these icons when hovered over and a brief description appears below it.

### Restaurant Tour

A simple floor plan of the restaurant is displayed with animated areas indicating the toilets, outdoor area, bar downstairs, and kitchen. There are icons next to the map which the customer can hover over which will highlight the toilets, the outside area, or bar and the best routes to get to them.

This floor plan could be 2D or 3D. It could predominantly be based on the drawings which blacksheep will be putting together for us. We could make this fun with quirky and amusing anecdotes or remarks. We could also include a mini-mpeg tour of us talking a walk through the restaurant, which then plays on the table as a mini movie in a similar manner to the chef-cam. We could punctuate it with humour, e.g. cutaway shots of our faces oooo-ing at the beautiful décor, nodding sagely. If we were to include the mpeg element we would probably want there to be drop down options to choose the video or map.

To close the tour of the restaurant the customer would simply navigate away from the page. There could be a time period after which if the system has not been interacted with it returns to a blank UI. A suitable length of time would probably be 2 minutes. Enough time to allow the customer to consult the map as to where the toilets are, for instance, leave the table to visit them, and then return to find that their UI has returned to its original state ready for use. There could also be an ‘I've seen enough’ button to pack everything away back to a blank UI.

### Meet Your Waiter

Upon selection, pictures and amusing anecdotes of our front of house members of staff appear on screen. These appear in passport style boxes all on one page. When hovered over, each box enlarges to show the detail more clearly. The other boxes shift to accommodate the enlargement when necessary.

To close the ‘meet your waiter’ details the customer simply navigates away from the page.

There could be a time period after which if the system has not been interacted with it returns to a blank UI. A suitable length of time would probably be 2 minutes. There could also be an ‘I've seen enough’ button to pack everything away back to a blank UI. The staff pictures display in bubbles rising up the page. As you catch each one it stops and zooms up and the others continue to rise around it. When they reach the top of the page they disappear reappearing at the bottom of the page.

### About Us

When opened the customer sees an area in which appears a text drop.

### Take Me Home

When the customer selects the ‘view me’ button for this section, two options appear as standard icons in the food/drinks menu these are Taxi and Public Transport.

Upon hover over, a brief description appears below the icons, and the option to show me more (a ‘show me’ button) pops up attached to the icon (as in the case of the food/drinks menu items).

### Taxi

If the customer selects cab, another stage appears in the form of two drop down icons—cf the food menu. These options are large cab and small cab. If the customer hovers over either option an enlarged image fades in below, and the option to ‘order me’ appears on the icon in the same manner as food and drink ordering. The options pack away after a short period of inaction.

If the customer confirms that they would like a small/large cab the maitre d′ is paged accordingly, and orders a cab for the occupants of that table. Afterwards, a message appears on table to inform the customer that their cab request has been received.

### Public Transport

When the public transport icon is selected a map of the local area and a tube map are loaded. One of these is overlaid over the other so that one can see all of one and part of the other. If the customer moves the cursor onto the other map the one underneath comes to the top. The maps could periodically switch over without the customer having to interact. The details could also simply be presented in a demarcated area on the right hand side. This would be the simplest method of presenting these details. The two maps could also be shown side by side and enlarge in turn when the customer hovers over one or the other.

To close the ‘map and public transport’ details the customer simply navigates away from the page. There could be a time period after which if the system has not been interacted with it returns to a blank UI. A suitable length of time would probably be 2 minutes. There could also be an ‘I've seen enough’ button to pack everything away back to a blank UI

### Additional Thoughts on Presentation of the Extras Menus.

### Table Moods

We could have colours and images (maybe even animations) projected onto the table thematically, e.g.:
Romantic—a dark, warm colour, with a lit candle projected onto the middle of the surface, and a rose, say. Presumably animating the candle would be too difficult—It could flicker every once in a while.
Authentic Oriental—a dark wood table surface, with oriental symbols.
Street—graffiti and Banksy style artwork projected onto the table.
Celebrity—small lapdog, shades, Lindsay Lohan's phone number on a card, etc.
Godfather—revolver, cards, etc, projected onto table.
Genteel/Silver Service—old fashioned dining table with table cloth, vast array of silver cutlery projected either side of the central white space for the plate.
Back to school—possibly have an old style school desk with ink well, and names scratched into it, fountain pen, etc, or a tray like for a school dinner.

### Where to Go?

This could be presented in the form of a little map with hotspots, about which more details appear either centrally or on the right hand side when hovered over or tapped.
   The view could zoom down onto the hotspot and then reveal interior photographs of the location. Closing the information would zoom back out to the higher view of Central London.
We could have a self-scrolling list of places to go and things to do, which could halt when hovered over, or only upon tap to view more details.

### Alternative: Could Also Have an Online Style Shop

For purchase of crockery, artwork, books, etc.

### Appendix I—Revenue Streams

The purpose of this section is to list specific ways that the WES system can be used to create new or optimised streams of revenue within the restaurant, bar, or various other environments.

### Within a Restaurant Environment

There will be a Faster Turnover of Customers Compared to Equivalently Priced Restaurants for Several Reasons:

### Faster Bill Payment

In the case where Chip &PIN terminals are present on the tables, customers will not have to wait for someone to pay their bill. In the case of no Chip &PIN terminals, waiters will be alerted more clearly and instantly that the customer is ready to pay their bill by the change of colour of the table.

### No Waiting Period for Food and Drink Ordering

A customer's order once pressed goes straight to the bar or kitchen and there is no need to wait for a waiter to come to the table.

A Customer can See How Long his Food will Take to Order Before he Orders it.

People wishing to have quick meals will be enticed by our restaurant hence increasing the average speed of dining.

Due to the faster turnover, a waiter will get more tips. This obviously does not provide a direct revenue stream to the restaurant itself but increases staff satisfaction and hence circularly this will have an effect on the number of customers.

Customers will Order More Items Because of the Automated Ordering System.

In an ordinary restaurant, customers often wish to order a beverage for especially when eating salty or spicy food but eventually choose not to because they fail to get a waiter's attention. This would not happen in a restaurant with the WES system. Customers often wish to order coffee before the bill but often give up because they fail to get a waiter's attention or because they expect that the waiter would take a while to arrive. This would not happen in a restaurant with the WES system. In both the above examples, the customer would also waste valuable table time attempting to get the waiter's attention. Using the projection system, customers can view exactly how the food and drink ordered will appear on their plate. As such there will be more impulse buying of food and drink.

### A Customer can Order Taxis Through WES During his Meal.

Specific deals could be set up with local cab companies and the restaurant can take a fee from either the cab company or put a small fee on the bill for this service.

A Customer can View Details of Local Pubs, Clubs and Bars through WES while Dining.

We would only recommend those places which we actually felt were good venues but within that context, marketing deals can be arranged whereby we get a small fee for every customer who they get through us or we could charge a direct fee for having a reserved place on the WES system. Equally we could look for them to promote us as a location.

This could also include a virtual tour of the local area where e.g. specific locations could be highlighted and full of colour and logos while others were just shapes with less substance.

We Could Charge Customers on the Basis of Time Spent at the Table and this Could be Administered through Information Displayed by the WES System.

There are many possible ways in which this could generate a revenue stream, many of which would be of great potential benefit to customers. A fixed rate cover charge could be automatically charged to every customer per time period. This would have the benefit of rotating customers more quickly and hence increasing customer turnover and allowing more customers to visit the venue if regularly at capacity.

Customers could receive discounts based on how long they spend at the table. Eg a 10% discount for leaving within 45 minutes, 30% discount for leaving within 30 minutes.

Drinks and food can be charged on the basis of how full the restaurant is.

Drinks and food could be charged at happy hour prices.

A Customer Can View TV or Stored Films through the WES System

This could be charged on a pay per view basis. In the case of a projector beaming the WES directly onto the table this could be a very high quality cinematic experience. We could also allow regular customers to buy subscription to our various available channels. A deal of some sort could potentially be struck which would allow customers to buy a subscription to their channels through us with us taking a small commission on this OR with us charging for table time (as stated above).

A Customer Can Register for “Club WES” through the WES System or our Website.

Through paid annual subscriptions various customisations and booking advantages could become available to the customer including extra features on the WES software, custom dish ratings etc.

### Using WES the Customer Can Book his Next Visit to the Restaurant.

A satisfied customer can immediately book another visit to the restaurant for any number of people. If a customer is impressed and, for example, wishes to bring a date to the restaurant, then occupancy of the restaurant will have been increased through the ease of booking.

A Customer Can View Sports Reports, Newspapers and Sports Results through WES.

This could be charged on a pay per view basis or as a subscription for registered customers.

A Customer Can Choose how Their Menu is Presented through WES—eg Calorie Controlled, Atkins Diet Approved etc.

The creators of specific healthy diets of which we approved could in principle be charged a small fee to have our database correlated to what fits in with their dietary structure.

### Singles Notice Board in WES System

Registered users of the WES system if choosing to put their photo in could have it viewed by other users. Other registered users could flag the people they like the look of and when two people flag each other and both happen to be in the restaurant on that day, they could be introduced by eg the Maitre d′. Customers could be charged in advance for this service or on the night the maitre d′ could ask one of them if he wished to buy the other a drink and upon so doing the restaurant has increased its revenue stream.

Competitions and Events Run through WES

Customers of any venue could be charged to participate in events run using the WES system. These events could include:

Singles/Dating Application Run through the WES System

A Singles/Dating night at our venue could be a carefully specified special features of the WES system. This could use many of the features which may already be part of the system—e.g. messaging, photos etc.

A speed dating night at our venue could work differently from one at another venue—everyone could stay put in their chairs and converse with their prospective partners through streaming video.

The customer could be charged for this on a nightly basis or on the basis of a one off payment to come to speed dater evenings. Or a customer could be charged only if he met someone he liked on the night. A customer could also be charged an annual subscription fee to participate in the all events.

Footsie Application Run through WES

Prices of food and drink fluctuate as people order like a stock exchange. A table of prices depicts movement up and down. There would be a minimum and maximum price for each product on offer—one which means we always get a reasonable profit, and the price never gets too ridiculous. We could have someone MC-ing this—starting and ending “trading”, shouting out really special prices, or sudden prearranged “crashes” on certain items that makes them really cheap for 10 minutes, etc. Screens in the venue for this period display the fluctuating drinks prices. Enabling people not seated at tables but ordering at the bar to participate in the process. This would allow greater stock control for the restaurant but also would be a fun application with the potential to draw people into the venue.

Film Night & Cinema Shown through WES

Either as a special event within a restaurant or other venue OR as a unique cinema venue. As a cinema each customer can watch the film at his own table with a group of friends and the customer could be charged for entry like any other cinema but could order food and drinks through the WES system during the movie. As a film night in a restaurant, the customer could be charged pay per view or on entry or by the time spent in the restaurant as above etc.

Digitised Pub Quiz through the WES System

The quiz can take several formats, including customers against other customers and individual tables looking to win prizes from the establishment. People can be charged a small fee for entry into the pub quiz

### “Who Wants to Win a Free Meal?” Application in WES

Certain nights/times run an optional quiz competition—perhaps hourly one evening a week for five minutes (30 seconds per question). You have to have placed an order (of a certain size?) to participate.

The more questions you try to answer the higher the prize you are set to win, but you have to risk all the previous winnings. Could offer a percentage off the total bill, meaning the more people spend the more they save as a result of the prize. People can win vouchers for money off next time they visit, drinks, food, up to a whole free meal for answering a ridiculously hard question.

Multiplayer games: Scrabble, Chess, Draughts etc.

Either as a unique gaming venue or as something to do during a night, people could be charged for entry, time spent at table or on a pay per game basis.

### Website Integration

The website can be integrated into our WES system or bookings from the website and others can be personally relayed to the Maitre' D. Customers can be charged a deposit for booking online. Customers with WES membership can book their meal in advance for a specific time increasing efficiency and occupancy as well as turnover. This can also help stock control.

### Betting Application

The screens can show football/rugby/etc and a direct link to e.g. Betfair.com with customer accounts through us—from which we take a percentage—either charging Betfair or the customer directly for this service.

It would also be possible to offer real-time specific in house bets only available to the people within that restaurant or gaming venue watching the sporting event and betting against each other or against us.

A unique gambling venue with Poker/Black jack/Roulette/other casino games played directly on the touchscreens or projected onto the tables could be arranged. This could also work well as a dining room within a casino.

### Wine Tasting Application

We could have a wine/beer tasting application/theme night where a table gets presented with five unlabelled/covered labelled bottles of wine and they have to taste each bottle (A->E) and pick/guess on screen the grape, the vintage, the price, the alcohol content etc.

Correct guesses can win prizes e.g get the bottle of wine for free. People could be charged for entering the competition or there could be a gaming aspect to it—bet upon how sure you are about the bottle of wine.

A pub quiz style game using this concept could also work well where people pay per game and for the wine in the process.

People could also be charged for educational wine and spirit courses taught by the WES system.

Events Run through the WES System

Corporate events or product launches are eminently doable (via our plasma screens on the walls) a single client could pay for the whole bill. Alternatively people could be issued with some form of company card with which to pay for items.

### Ego Tripping

Customers could pay to have their name displayed on all the WES to attempt to impress dates, friends etc.

Advertising through WES

Specific advertising for companies can be displayed through the WES screens. Companies can be charged for this advertising space on a per screen, per table, or time basis.

There are many places within WES where this advertising could appear. Either as a screensaver, as a specific advertising screen within the WES system or as a constant place on the table.

Could have a box projected into the middle of the table within the rest of the WES software offering a percentage discount to the customer if they are willing to be presented with advertising in that box. The company advertising would be charged each time a customer accepted these terms and a profit would be made on each advert. This would also have quite unique market penetration.

Adverts could also be projected from the WES system on to chairs, flatware, floors, walls, ceilings, flowers, glasses, cutlery, china and tableware.

### Ambience Control Using WES

A customer could be charged for implementing the ambience control (setting the specific hue of lighting within his restaurant space.) This is not something we would initially want to do but if a table of four was fighting over the shading at their table, after it had been set a couple of times by each person a message could appear saying that it would start to be charged to their bill.

Today's Special and Recommendations through WES

A customer could be recommended a drink or dish to accompany certain other dishes which if they order increases our revenue stream. NB Such recommendations would be genuine and not just a form of stock control.

A customer could be offered today's special through the WES system. The WES system automatically detects which dishes we have lots of stock for and would be helpful to sell and offers the customer discounts on these dishes. This improves stock control and hence increases revenue.

### Set Up and Sell Space on the WES System to Software Developers.

Early versions of games and applets can be trialled and tested on audiences either as freeware, shareware etc. and either the customer or the software developer can be charged for this.

### Audio Books AND Visual Books

Customers could pay to listen to an audio book or read an uploaded magazine through the WES system.

### Video Conferencing

Customers could have a full video conference between themselves and a customer at any other inamo restaurant through the WES system. Customers could be charged by the minute, the hour, as a single cover charge etc.

Customers can actually use WES system at the tables to talk to someone anywhere in the world on a mobile phone, interne phone, landline video phone or plain audio phone. We could charge the customers or the phone companies for this service.

### Streamed Live Music

Live music at any one inamo restaurant can be streamed to any inamo restaurant live. People in London could view live music from inamo New York or inamo Tokyo or for that matter in principle from any live gig across the world. People could be charged by time or pay per view or it could be used simply to increase occupancy of the restaurant. A customer could also purchase a digital copy of this to take home with him that evening.

### Drinking Games

While potentially irresponsible we note that it is possible to have automated drinking games whereby people failing specific tasks have drinks ordered for them by the system automatically dramatically increasing revenue stream. Customers would have to agree to the terms of the game in advance and limits could be set on the amount of booze that could be ordered within the game from each seat. This could all be arranged through the WES in such a way as to ensure more responsible drinking even within the game using booze limits and warning messages. The drinks could also get less strong in alcohol terms as the game went on.

### Linking Laptops

In principle a customer could link his Laptop to the WES system and give, for example, a PowerPoint presentation directly onto the table for others seated with him and could be charged for the WES laptop interface. USB devices etc. could also be linked.

### Auction Applications

Customers can bid for items which are for sale at a restaurant through the WES software. This could also be run as a unique auction venue whereby customers bid for all the objects that are for sale through WES at their seats/tables and can see the items displayed in front of them. This could be combined with or independent of a live auctioneer. People at other inamo locations could log in to the auction venue through the WES software and either the customer or the auctioneer can be charged for this service.

### Appendix II Hardware System Overview

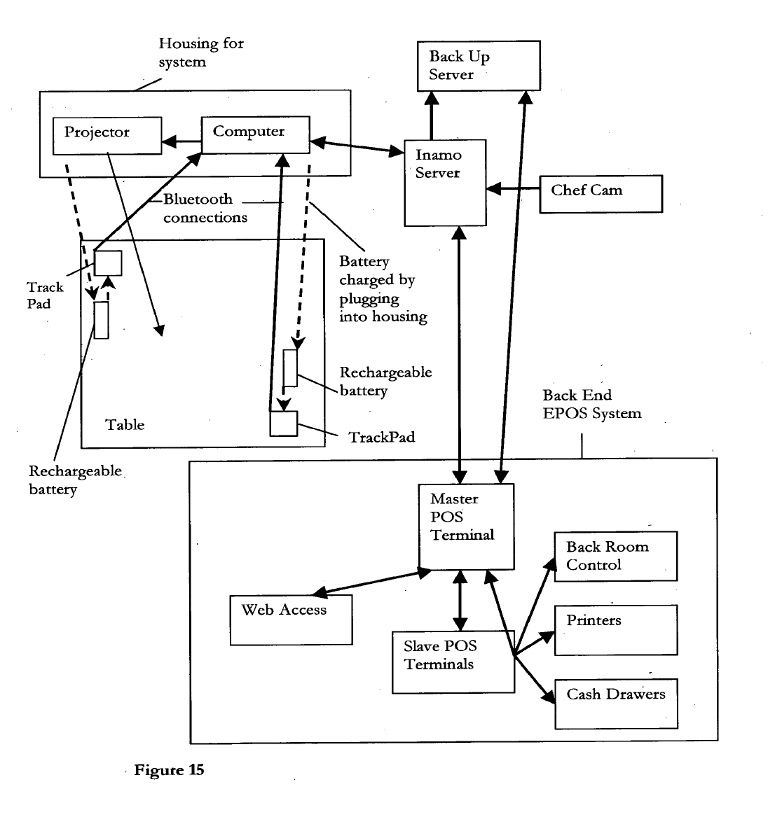

FIG. 15 shows a diagram of a typical restaurant table system which implements an example of the invention, and the connection of the restaurant table system via a server to other peripherals or networks.

In FIG. 15, a restaurant table for two diners is shown. A TrackPad is shown for each diner. Each TrackPad is connected wirelessly to an overhead computer. The TrackPads are each powered by a rechargeable battery. Each battery is recharged via a cable which may be pulled down from overhead and connected to the battery, preferably while customers are not present in the restaurant. This saves having to provide power to the tables. A projector is shown mounted above the table for illuminating the table surface. The projector above the table is connected to the computer above the table, both of which are in the same housing. The computer above the table is connected to a server which controls the computer for each of 45 tables for two diners. The server is the Inamo Server.

In FIG. 15, the Inamo Server is connected to a backup server, the chef camera, and to a Master Point of Sale (POS) Terminal. The Master POS Terminal is connected to web access, Slave POS Terminals, which are in turn connected to a Back Room Control system, printers, and to cash drawers. The Back End electronic POS (EPOS) system comprises the Master POS Terminal, web access, Slave POS Terminals, Back Room Control, printers, and cash drawers. In FIG. 15, the computer (eg. Client PC) is connected to the Inamo server (running the WES software) which interacts with a POS server—eg. one supplied by Sharp but it could be any (e.g. Aloha Systems, Micros, Fourth etc.). It is the POS Terminal which interacts with the back end equipment. All devices (including track pads, client PCs, projectors, inamo server, master POS terminal, slave POS terminals, back room control, printers, chef camera etc are networked devices, each with an IP address.

1. Restaurant multiplayer game system, the system including a restaurant, a computer, a horizontal projection surface located within the restaurant and a projector located within the restaurant, the projector mounted above the horizontal projection surface, the computer arranged to control the projector, the computer arranged to run a multiplayer game program corresponding to a multiplayer game, wherein the projector is arranged to project multiplayer game images onto the horizontal projection surface, wherein the multiplayer game is playable by multiple individuals who are located within the restaurant.

2. The system of claim 1, wherein the system is configured to receive user input which is provided by hovering over projected objects with one or more fingers, or with a palm of a hand.

3. The system of claim 1, wherein the system is configured to receive user input which is provided by tapping on projected objects with one or more fingers, or with a palm of a hand.

4. The system of claim 1, wherein a plurality of multiplayer games are presented for selection.

5. The system of claim 4, wherein the computer is arranged to receive a selection of a multiplayer game, and to run a multiplayer game program corresponding to the selected multiplayer game.

6. The system of claim 4, wherein the multiplayer games are presented for selection as selectable bubbles.

7. The system of claim 6, wherein a selectable bubble is tapped or hovered over to launch a multiplayer game.

8. The system of claim 6, wherein the selectable bubbles rise up the projection surface.

9. The system of claim 8, wherein when a selectable bubble reaches the top of the projection surface, the selectable bubble disappears and it reappears at the bottom of the projection surface.

10. The system of claim 4, wherein the multiplayer games are presented for selection in square format.

11. The system of claim 4, wherein the multiplayer games are presented for selection as in a top level for selectable items on a DVD user interface.

12. The system of claim 4, wherein the multiplayer games are presented for selection as icons including animated graphics, or in which multiplayer games are presented for selection as icons including gently animated graphics.

13. The system of claim 4, wherein the multiplayer games are presented for selection as icons including simple images which are iconic with the game genre.

14. The system of claim 4, wherein offered multiplayer games drop down from an icon.

15. The system of claim 4, wherein for a selectable multiplayer game, explanatory text is provided including details of the multiplayer game and how it is played.

16. The system of claim 1, wherein a button is provided in a gaming area for the customer to obtain a blank user interface.

17. The system of claim 4, wherein the multiplayer games include a memory game, a quiz game, chess, scrabble, or draughts.

18. The system of claim 4, wherein the multiplayer games include a game which can continue to play indefinitely.

20. The system of claim 4, wherein the system includes a trackpad, and the multiplayer games are well suited to trackpad interaction.

21. The system of claim 4, wherein the multiplayer games include short games.

22. The system of claim 4, wherein the multiplayer games are only short games.

23. The system of claim 4, wherein the multiplayer games provide stateless operation.

24. The system of claim 1, wherein a multiplayer game includes a pause function.

25. The system of claim 24, wherein a user can resume a paused multiplayer game after browsing other areas of the system.

26. The system of claim 4, wherein the multiplayer games include gambling games.

27. The system of claim 26, wherein the gambling games include poker, Black jack or roulette.

28. The system of claim 4, wherein the multiplayer games include drinking games.

29. The system of claim 1, wherein users pay per game.

30. The system of claim 1, wherein the system is configured to enter a sleep mode after an interval without interaction, or in which the system is configured to enter a sleep mode after an interval without interaction with a multiplayer game.

32. The system of claim 1, wherein the horizontal projection surface is a table surface.

33. The system of claim 32, wherein the computer is configured to receive a selection of a different lighting for the table, for projection onto the surface by the projector, or in which the computer is configured to receive a selection of different images for the table, for projection onto the surface by the projector, or in which the computer is configured to receive a selection of different streamed films for the table, for projection onto the surface by the projector, or in which the computer is configured to receive a selection of different skins for the table, for projection onto the surface by the projector.
